(19) United States
(12) Patent Application Publication
(10) Pub. No.: US 2026/0190008 A1
(43) Pub. Date: Jul. 2, 2026

(54) COMMUNICATION SYSTEM, CONTROL METHOD FOR THE SAME, AND STORAGE MEDIUM

(71) Applicant: SORACOM, INC., Tokyo (JP)

(72) Inventors: Yusuke MATSUMOTO, Tokyo (JP); Tadashi TSUJI, Tokyo (JP); Shozo OKASAKA, Kanagawa (JP); Taichi MIYA, Kanagawa (JP)

(21) Appl. No.: 19/549,611

(22) Filed: Feb. 25, 2026

Related U.S. Application Data
(63) Continuation of application No. PCT/JP2025/002314, filed on Jan. 24, 2025.

(30) Foreign Application Priority Data
Jan. 29, 2024 (JP) 2024-011230

(51) Int. Cl. H04W 48/08; H04W 8/16; H04W 8/18; H04W 28/06

(52) U.S. Cl. CPC H04W 48/08; H04W 8/16; H04W 8/18; H04W 28/06

(57) ABSTRACT

A communication system includes a communication unit configured to perform processing related to communication of a user device and a management unit configured to manage subscriber identification information that is subject to communication restriction. The communication unit restricts communication of a restricted user device associated with subscriber identification information that is managed as being subject to communication restriction.

### CROSS-REFERENCE TO RELATED APPLICATION(S)

This application is a continuation of International Patent Application No. PCT/JP2025/002314 filed on January 24, 2025, which claims priority to and the benefit of Japanese Patent Application No. 2024-011230 filed January 29, 2024, the entire disclosures of which are incorporated herein by reference.

### BACKGROUND OF THE INVENTION

### Field of the Invention

The present invention relates to a communication system, a control method for the same, and a storage medium.

### Description of the Related Art

A mobile communication network provides a service for a user device to communicate with an external network. International Publication No. 2017/056201describes that data transmitted by a user device is transferred to a server corresponding to a destination network. Depending on a subscriber's status, a communication operator may restrict communication performed by a user device.

### SUMMARY OF THE INVENTION

Some aspects of the present invention provide a technique for enabling restriction of communication of a user device as intended. According to some embodiments, a communication system comprising: a communication unit configured to perform processing related to communication of a user device; and a management unit configured to managing subscriber identification information that is subject to communication restriction, wherein the communication unit restricts communication of a restricted user device associated with subscriber identification information that is managed as being subject to communication restriction is provided.

Further features of the present invention will become apparent from the following description of exemplary embodiments with reference to the attached drawings.

### BRIEF DESCRIPTION OF THE DRAWINGS

FIG. 1 is a block diagram illustrating an example of a configuration of a mobile communication network according to some embodiments.

FIG. 2 is a block diagram illustrating an example of a hardware configuration of a computer according to some embodiments.

FIG. 3 is a block diagram illustrating an example of a protocol configuration according to some embodiments.

FIG. 4 is a block diagram illustrating an example of a configuration of a P-GW according to some embodiments.

FIG. 5 is a diagram illustrating an example of transferring information according to some embodiments.

FIG. 6 is a flow diagram illustrating an example of operation of a communication system according to some embodiments.

FIG. 7A is a sequence diagram illustrating an example of operation of a communication system according to some embodiments.

FIG. 7B is a sequence diagram illustrating an example of operation of a communication system according to some embodiments.

FIG. 8 is a sequence diagram illustrating an example of operation of a communication system according to some embodiments.

FIG. 9 is a sequence diagram illustrating an example of operation of a communication system according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

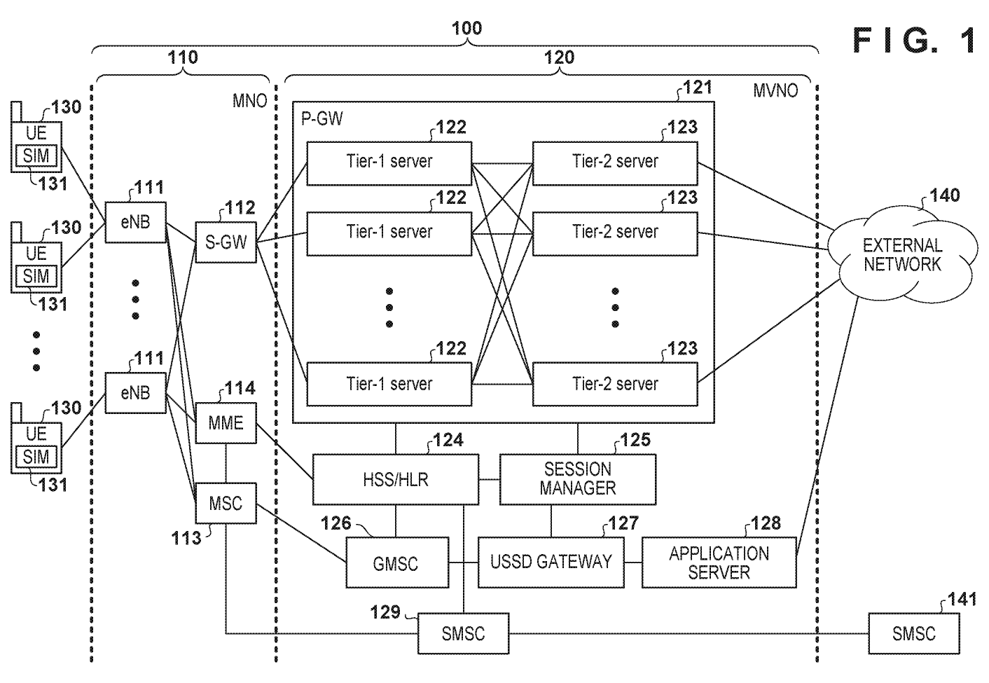

A configuration of a mobile communication network 100 according to some embodiments of the present invention will be described with reference to FIG. 1. FIG. 1 illustrates a mobile communication network conforming to LTE (Long Term Evolution). The present invention is also applicable to a mobile communication network conforming to 3G, 5G, or another standard. The mobile communication network 100 provides a communication service to user devices (UEs) 130. The mobile communication network 100 may be constituted by a communication system 110 and a communication system 120. Any of the constituent elements included in the mobile communication network 100 may be an entity that performs processing related to communication of the UEs 130.

The communication system 110 may include an evolved Node B (eNB) 111, a Serving Gateway (S-GW) 112, a Mobile Switching Center (MSC) 113, and a Mobility Management Entity (MME) 114. The communication system 120 may also include a Packet data network Gateway (P-GW) 121, a Home Subscriber Server/Home Location Register (HSS/HLR) 124, a session manager 125, a Gateway Mobile Switching Center (GMSC) 126, an Unstructured Supplementary Service Data (USSD) gateway 127, an application server 128, and a Short Message Service Center (SMSC) 129. In the example of FIG. 1, the communication system 110 is provided by a Mobile Network Operator (MNO), and the communication system 120 is provided by a Mobile Virtual Network Operator (MVNO). Alternatively, both the communication system 110 and the communication system 120 may be provided by an MNO. The P-GW 121 and the session manager 125 may be constructed by the MVNO itself, or may be constructed and operated by a Mobile Virtual Network Enabler (MVNE) at the request of the MVNO. The S-GW 112 may be included in the communication system 120 provided by the MVNO instead of being included in the communication system 110 provided by the MNO.

The UE 130 is a device that can use the communication service provided by the mobile communication network 100. The UE 130 may be, for example, a mobile phone, a personal computer, a sensor, an actuator, or the like. In particular, the UE 130 may be an Internet of Things (IoT) device. The UE 130 has a SIM 131. The SIM 131 is an integrated circuit that stores data and programs used for communication with the mobile communication network 100. The SIM 131 may be an Embedded SIM (eSIM) or a physical SIM. The SIM 131 stores an International Mobile Subscriber Identity (IMSI) assigned by the operator of the communication system 120. The IMSI is an example of subscriber identification information that is uniquely assigned to each subscription contract. The SIM 131 may store only one IMSI or may store a plurality of IMSIs. If the SIM 131 stores a plurality of IMSIs, the UE 130 may select any of the plurality of IMSIs to communicate with the mobile communication network 100 or another mobile communication network. The plurality of IMSIs may be stored in physically different SIMs or may be stored in the same SIM.

The mobile communication network 100 provides a function of packet communication between the UEs 130 and an external network 140. A packet is an IP datagram, an Ethernet frame, or any protocol data unit, all of which are data units transmitted and received at the network layer according to the Internet Protocol (IP).

The eNB 111 connects the UE 130 to the S-GW 112 and transfers packets between the UE 130 and the S-GW 112. In this specification, an entity of the mobile communication network 100 (e.g., the eNB 111, the S-GW 112, the P-GW 121, etc.) may add/modify/delete a portion of the packets (e.g., the headers, etc.) or split or combine packets when transferring the packets. Thus, transferring a packet may be transmitting a received packet as-is, or may be transmitting a new packet that is based on at least a portion of a received packet. The eNB 111 also provides the UE 130 with a radio resource management function, a mobility management function, a scheduling function, and the like. The eNB 111 connects the UE 130 to the MSC 113 and transfers data between the UE 130 and the MSC 113. Data transferred between the UE 130 and the MSC 113 may include audio data, messages, and the like.

The HSS/HLR 124 manages information about the subscribers of the mobile communication network 100. For example, the HSS/HLR 124 stores location information, service subscription information, authentication information, and the like of the subscribers, and performs addition, modification, deletion, and the like of this information.

The S-GW 112 provides the function of routing packets from or to the UE 130. The S-GW 112 corresponds to a Serving GPRS Support Node (SGSN) in a 3G network.

The P-GW 121 has a function of providing the UE 130 with access to the external network 140. The P-GW 121 is a gateway device that functions as an endpoint of a core network included in the mobile communication network 100. The external network 140 is a network different from the mobile communication network 100. The external network 140 may include a public network such as the Internet, or a private network provided by an individual company or the like. The P-GW 121 corresponds to the Gateway GPRS Support Node (GGSN) in a 3G network and the Session Management Function (SMF) and User Plane Function (UPF) in a 5G network.

Packets from the eNB 111 to the P-GW 121 are transferred in an encapsulated state through a tunnel (GTP tunnel) established in accordance with the GPRS Tunneling Protocol (GTP). Instead of the GTP tunnel, another Layer 2 (L2) tunnel may be used.

The P-GW 121 may be constituted by one or more Tier-1 servers 122 and one or more Tier-2 servers 123. In the example of FIG. 1, the P-GW 121 is constituted by a plurality of Tier-1 servers 122 and a plurality of Tier-2 servers 123. The Tier-1 servers 122 are connected to the S-GW 112. The Tier-1 server 122 receives a packet transmitted by the UE 130 and transferred by the S-GW 112. The Tier-1 server 122 transfers this packet to the one or more Tier-2 servers 123. In addition, the Tier-1 server 122 transfers a packet that any of the Tier-2 servers 123 has received from the external network 140 to the S-GW 112.

The Tier-2 server 123 receives the packet transferred from the Tier-1 server. The Tier-2 server 123 may transfer this packet to the external network 140. As will be described later, any one of the plurality of Tier-2 servers 123 may discard at least a portion of the packet transferred from the Tier-1 server 122. The Tier-2 server 123 may provide various services for communication by the UE 130. For example, the Tier-2 server 123 may function as a Network Address Translation (NAT) that performs processing in the network layer or as a proxy that performs processing in the application layer. Furthermore, the Tier-2 server 123 may perform image and video processing, credential provisioning, and the like, instead of the UE 130.

The maximum number of servers that can be simultaneously connected to the S-GW 112 as the P-GW 121 is determined by the MNO. In view of this, in this embodiment, by separating the P-GW 121 into a server (Tier-1 server 122) that exchanges packets (data) with the S-GW 112 and a server (Tier-2 server 123) that provides access to the external network 140 and various additional services, the number of Tier-2 servers 123 can be increased beyond the maximum number of connected servers set by the MNO.

The session manager 125 is a server for controlling the operation of the P-GW 121. The session manager 125 may also be called a control server. For example, the session manager 125 may select the Tier-2 server 123 to which the Tier-1 server 122 transfers the packet. The detailed operation of the session manager 125 will be described later.

The MSC 113 is a switching center that sets up and releases a call path to and from the UE 130. The MSC 113 transfers the data received from the UE 130 to the GMSC 126 and the SMSC 129. For example, the MSC 113 may transfer an SMS message transmitted by the UE 130 to the SMSC 129. The MSC 113 may transfer the USSD message transmitted by the UE 130 to the GMSC 126.

The MME 114 is an entity that handles location information and paging of the UE 130, mobility control, bearer establishment and deletion, and the like. The MME 114 may authenticate the UE 130 based on authentication information notified by the HSS/HLR 124.

The GMSC 126 is a switching center that mutually connects with telephone networks and other mobile communication networks. The GMSC 126 may transfer a USSD message received from the UE 130 via the MSC 113 to the USSD gateway 127. The USSD gateway 127 transfers the USSD message to the application server 128. The application server 128 processes the USSD message. For example, the application server 128 may convert the USSD message into a TCP/IP protocol and transmit it to the external network 140.

The SMSC 129 is a switching center that transmits and receives SMS messages. The SMSC 129 may transfer the SMS message received from the UE 130 via the MSC 113 to an SMSC 141 in another mobile communication network, or transmit it to the destination UE 130 connected to the mobile communication network 100. The SMSC 129 may also transmit the SMS message received from the SMSC 141 to the destination UE 130 connected to the mobile communication network 100.

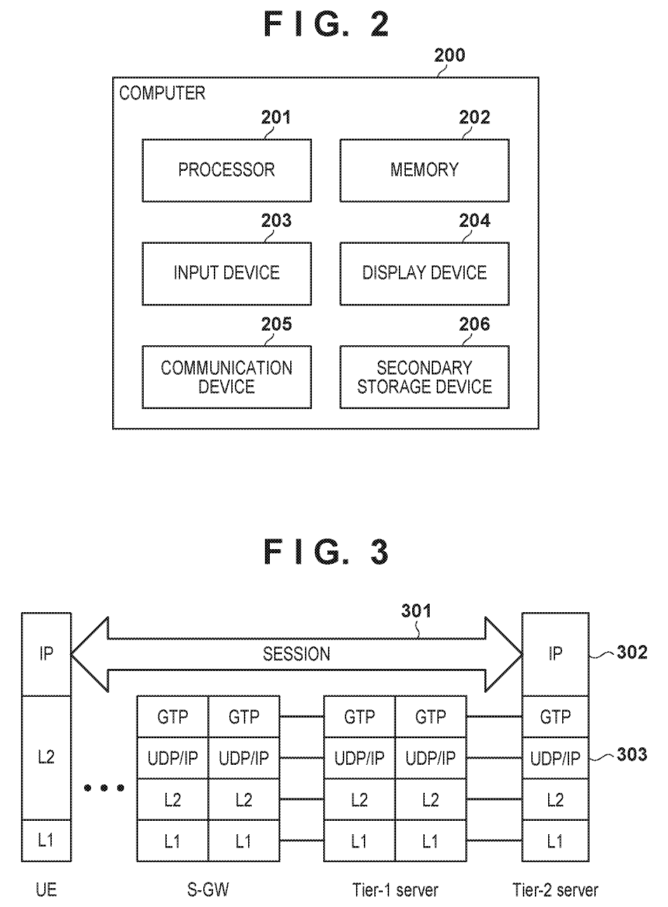

Next, an example of the hardware configuration of the computer 200 according to some embodiments will be described with reference to FIG. 2. The computer 200 may be used to implement any of the constituent elements of the mobile communication network 100. Each constituent element of the mobile communication network 100 may be implemented in one computer 200 or may be distributed and implemented across a plurality of computers 200. In addition, two or more constituent elements of the mobile communication network 100 may be implemented in one computer 200.

The computer 200 may be disposed in an on-premises environment. Alternatively or additionally, a cloud may be formed by a plurality of computers 200, and any constituent element of the mobile communication network 100 may be implemented by a virtual machine of the cloud (i.e., as an instance of the cloud). The cloud may be a public cloud such as Amazon Web Services (AWS), or may be a private cloud constructed for a single company. When the cloud is a public cloud, one or more Tier-1 servers 122 and one or more Tier-2 servers 123 may belong to a virtual private network on the cloud. For example, if the cloud is AWS, a virtual private network may be constructed using a Virtual Private Cloud (VPC) function.

By constructing the P-GW 121 on the cloud, the performance of the P-GW121 can be changed at the appropriate timing depending on the processing status of the P-GW 121. Changing the performance of the P-GW 121 may be achieved by replacing one server with another server (a server with higher or lower processing power than the original server) (what is called scaling up/scaling down), or by changing the number of servers (what is called scaling out/scaling in).

The computer 200 may have the hardware shown in FIG. 2. A processor 201 controls the overall operation of the computer 200. The processor 201 may be constituted by, for example, a Central Processing Unit (CPU). The processor 201 may be a single processor or an aggregate of a plurality of processors connected to each other in a communication-enabling manner.

A memory 202 stores programs and data used in the operation of the computer 200. The memory 202 may be constituted, for example, by a combination of a Random Access Memory (RAM) and a Read Only Memory (ROM). The operation of each constituent element of the mobile communication network 100 may be performed by the processor 201 executing a program loaded into the memory 202. Alternatively, at least a portion of the operation of each constituent element of the mobile communication network 100 may be executed by a dedicated integrated circuit such as an Application Specific Integrated Circuit (ASIC).

An input device 203 is a device for acquiring instructions from the user of the computer 200. The input device 203 may be constituted by a combination of one or more of a keyboard, a button, a touchpad, and a microphone, for example. A display device 204 is a device for visually presenting information to a user of the computer 200. The display device 204 may be a dot matrix display such as a liquid crystal display. The input device 203 and the display device 204 may be outside of the computer. In this case, the computer 200 may have an interface for communicating with the external input device 203 and display device 204.

The communication device 205 is a device for communicating with devices outside the computer 200. If the computer 200 performs wired communication, the communication device 205 may be a Network Interface Card (NIC) having a connector for connecting a cable. If the computer 200 performs wireless communication, the communication device 205 may be a wireless communication module including an antenna and a baseband processing circuit.

A secondary storage device 206 is a device for non-volatile storage of programs and data used in the processing of the computer 200. The secondary storage device 206 is constituted by, for example, a Hard Disk Drive (HDD) or a Solid State Drive (SSD).

Next, an example of a protocol configuration of a U-plane (user plane) of the mobile communication network 100 of FIG. 1 will be described with reference to FIG. 3. An end-to-end session 301 is established between the UE 130 and the Tier-2 server 123. A packet transmitted from the UE 130 is transferred to the Tier-2 server 123 through the session 301. The Tier-2 server 123 is assigned an IP address to be used for an IP connection 302 with the UE 130 and an IP address to be used for an IP connection 303 with the Tier-1 server 122. An IP packet from the UE 130 is transferred through an IP connection 302 , and a GTP packet from the Tier-1 server 122 is transferred through an IP connection 303.

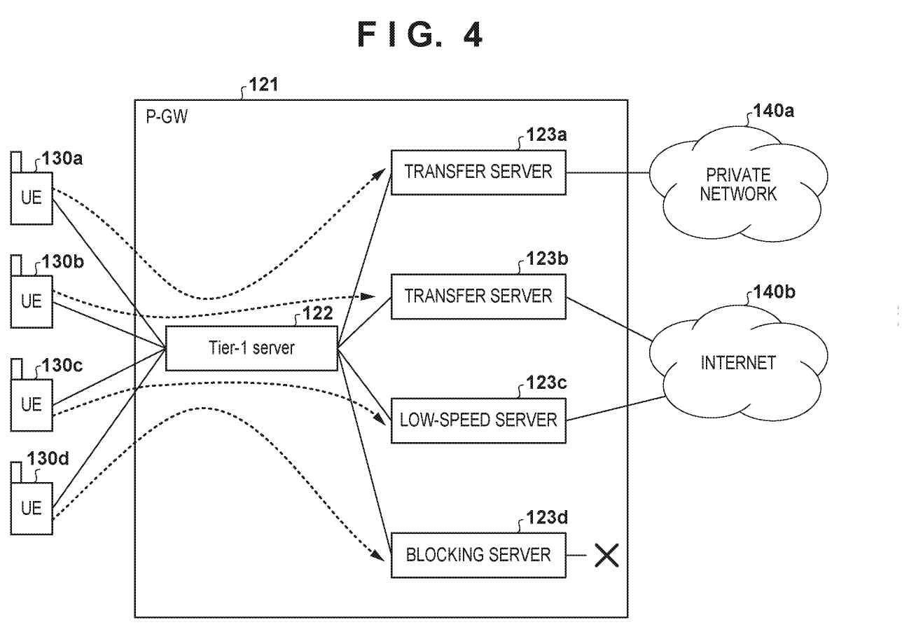

Next, an example of the configuration of the P-GW 121 will be described with reference to FIG. 4. In FIG. 4, a case where the P-GW 121 includes one Tier-1 server 122 will be described in order to simplify the description. If the P-GW 121 includes a plurality of Tier-1 servers 122, each of the plurality of Tier-1 servers 122 may execute the following operations. In addition, in the description of FIG. 4, the four UEs 130 are given subscripts as UEs 130a to 130d in order to distinguish them from one another. It is assumed that the external network 140 includes a private network 140a and the Internet 140b. It is assumed that the P-GW 121 includes four Tier-2 servers 123. The four Tier-2 servers 123 are given subscripts as Tier-2 servers 123a to 123d in order to distinguish them from one another. Furthermore, according to their roles, the Tier-2 servers 123a to 123d are referred to as a transfer server 123a, a transfer server 123b, a low-speed server 123c, and a blocking server 123d.

It is assumed that the communication operator (specifically, the MVNO; the same applies hereinafter) has stipulated that the UE 130a can access only the private network 140a through the mobile communication network 100. The Tier-1 server 122 transfers a packet transmitted from the UE 130a to the transfer server 123a. The transfer server 123a is configured to be able to access only the private network 140a. The transfer server 123a transfers the packet transferred from the Tier-1 server 122, to the private network 140a. Accordingly, the packet transmitted by the UE 130a is transferred to only the private network 140a. The UE 130a may also be able to access both the private network 140a and the Internet 140b. In this case, the transfer server 123a is configured to be able to access both the private network 140a and the Internet 140b.

It is assumed that the communication operator (specifically, the MVNO; the same applies below) has stipulated that the UE 130b can access only the Internet 140b through the mobile communication network 100. The Tier-1 server 122 transfers a packet transmitted from the UE 130b to the transfer server 123b. The transfer server 123b is configured to be able to access only the Internet 140b. The transfer server 123b transfers the packet transferred from the Tier-1 server 122, to the Internet 140b. Accordingly, the packet transmitted by the UE 130b is transferred to only the Internet 140b.

It is assumed that the UEs 130c and 130d are restricted from communicating through the mobile communication network 100. For example, communication by the UE 130 may be restricted by the communication operator if the UE 130 uses up all of the communication capacity stipulated in the contract, if the contract period for the communications service has expired, or if the fee for the communication service is unpaid. The restriction on communication may be a reduction of the communication speed or a blocking of communication. The following describes a case where the carrier can both reduce the communication speed and block communication. Alternatively, the carrier may be able to either reduce the communication speed or block communication.

It is assumed that the communication operator has stipulated that the UE 130c can access only the Internet 140b through the mobile communication network 100 at a low speed. The Tier-1 server 122 transfers a packet transmitted from the UE 130c to the low-speed server 123c. The low-speed server 123c transfers, to the Internet 140b, the packet transferred from the Tier-1 server 122. Accordingly, the packet transmitted by the UE 130c is transferred to only the Internet 140b. Furthermore, the low-speed server 123c discards only some of the packets transferred from the Tier-1 server 122, and transfers the remaining packets to the Internet 140b. In this way, the low-speed server 123c reduces the communication speed of the UE 130c. For example, if the communication speed of the packets transferred from the low-speed server 123c to the Internet 140b exceeds a maximum speed (e.g., 1 kbps) stipulated by the communication operator, the low-speed server 123c may discard the excess packets. The UE 130c may also be able to access a private network instead of or in addition to the Internet 140b, at a low speed.

It is assumed that the communication operator prohibits the UE 130d from communicating through the mobile communication network 100. The Tier-1 server 122 transfers, to the blocking server 123d, the packet transmitted from the UE 130d. The blocking server 123d discards all packets transferred from the Tier-1 server 122. In this way, the blocking server 123d blocks communication of the UE 130d. The blocking server 123d may discard the packets using a firewall function of an operating system (OS) (e.g., Linux (registered trademark)).

As described above, the low-speed server 123c and the blocking server 123d restrict the communication of the UE 130 by discarding at least some of the packets transferred from the Tier-1 server 122. For this reason, both the low-speed server 123c and the blocking server 123d may be called restriction servers.

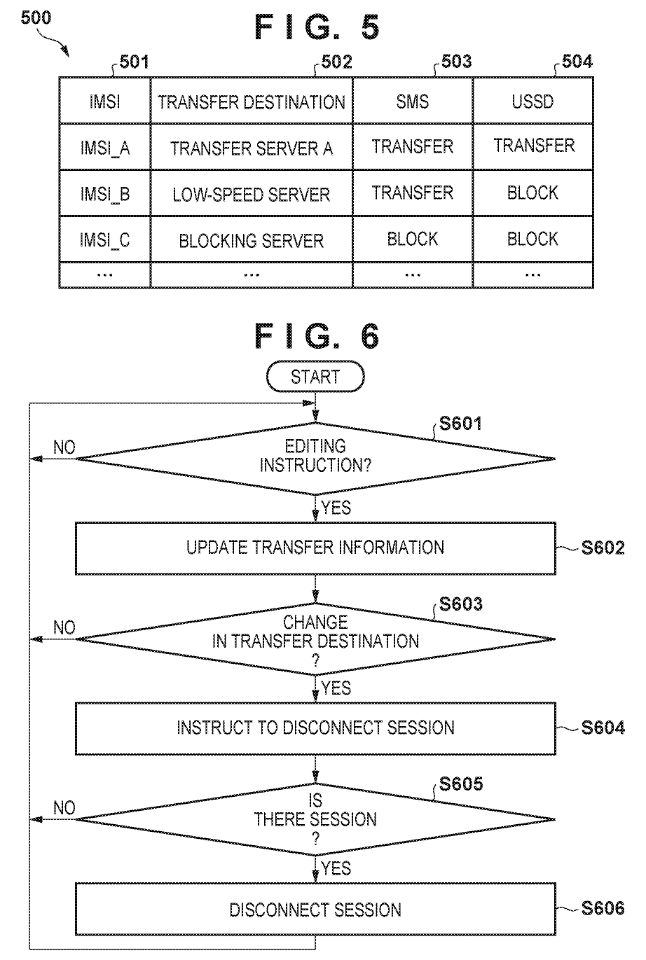

An example of transfer information 500 will be described with reference to FIG. 5. The transfer information 500 may refer to information regarding the transfer of data from the UE 130 by the communication system 120. In FIG. 5, the transfer information 500 is managed in table format. Alternatively, the transfer information 500 may also be managed in another format. The transfer information 500 may also be managed by the session manager 125, for example. Specifically, the transfer information 500 may be stored in a storage unit of the session manager 125 (the memory 202 or the secondary storage device 206 of the computer 200 including the session manager 125).

The transfer information 500 has an entry for each subscriber of the mobile communication network 100. Each entry in the transfer information 500 represents the settings for an individual subscriber. Column 501 of the transfer information 500 indicates the identification information of each subscriber, that is, subscriber identification information. The subscriber identification information used in the mobile communication network 100 may be any information that uniquely identifies a subscriber, and in the example of FIG. 5, the IMSI is used as an example of the subscriber identification information. Column 501 may include other subscriber identification information, such as a Subscription Permanent Identifier (SUPI), an ICCID, or a Mobile Station International Subscriber Directory Number (MDISDN), instead of or in addition to the IMSI. For example, column 501 may include both the IMSI and the MSISDN as subscriber identification information. If column 501 includes a plurality of types of subscriber identification information, column 501 may be divided into a plurality of columns. Furthermore, if the identification information of the UE 130 (e.g., International Mobile Equipment Identifier (IMEI)) is associated with a subscriber, the identification information of the UE 130 may be used as the subscriber identification information.

Column 502 of the transfer information 500 indicates the identification information of the Tier-2 server 123 assigned to each subscriber. If the communication system 120 includes a plurality of the P-GWs 121, column 502 may represent identification information indicating any one of the P-GWs 121. The identification information of the Tier-2 server 123 may be, for example, an identifier uniquely assigned to each Tier-2 server 123 by the operator. Alternatively, the identification information of the Tier-2 server 123 may be the IP address of the Tier-2 server 123. Each subscriber is assigned one of the plurality of Tier-2 servers 123 included in the P-GW 121. Alternatively, two or more Tier-2 servers 123 having the same functions may be assigned to at least one subscriber. As described above, a subscriber whose transfer destination is the low-speed server 123c or the blocking server 123d is restricted from packet communication. On the other hand, a subscriber whose transfer destination is the transfer server 123a or the transfer server 123b is not restricted from packet communication.

Column 503 of the transfer information 500 indicates whether or not each subscriber is permitted to use the SMS service. In the example of FIG. 5, a subscriber with “transfer” in column 503 is permitted to use the SMS service, and the mobile communication network 100 will transfer the subscriber's SMS messages. A subscriber with “blocked” in column 503 is restricted (specifically, prohibited) from using the SMS service, and the mobile communication network 100 blocks SMS messages from this subscriber. The permission to use the SMS service may be stipulated in more detail in the transfer information 500. For example, the transfer information 500 may independently manage a message transmitted by the UE 130 (i.e., a mobile originated message) and a message received by the UE 130 (i.e., a mobile terminated message). In addition, the transfer information 500 may individually permit or prohibit use of the SMS service for a specific transmission source or a specific transmission destination. For example, the transfer information 500 may prohibit general message transmission and reception by users (e.g., message transmission and reception between users), while permitting message transmission and reception between a user and a support center or subscriber information management server of a communication operator.

Column 504 of the transfer information 500 indicates whether or not each subscriber is permitted to use the USSD service. In the example of FIG. 5, a subscriber with “transfer” in column 504 is permitted to use the USSD service, and the mobile communication network 100 transfers the USSD messages of the subscriber. A subscriber with “blocked” in column 504 is restricted (specifically, prohibited) from using the USSD service, and the mobile communication network 100 blocks USSD messages from this subscriber.

In the example of FIG. 5, an SMS service and a USSD service are used as examples of messaging services. Alternatively, the transfer information 500 may indicate whether or not the subscriber is permitted to use another messaging service. For example, the transfer information 500 may indicate whether or not the subscriber is permitted to use a call service.

In the example of FIG. 5, the session manager 125 uses the transfer information 500 to manage subscriber identification information that is subject to communication restriction. Furthermore, the session manager 125 uses the transfer information 500 to manage the subscriber identification information that is subject to communication restriction for each subscriber (specifically, for each piece of subscriber identification information) separately for packet communication and the messaging service. Alternatively, the session manager 125 may manage subscriber identification information that is subject to communication restriction regarding packet communication only, or may manage subscriber identification information that is subject to communication restriction regarding the messaging service only.

The session manager 125 may provide an Application Programming Interface (API) for editing the transfer information 500. Through this API, an external entity (e.g., an administrator of a communication operator or a billing server program) may be able to edit the transfer information 500. For example, an external entity may instruct the session manager 125 to edit the transfer information 500 (e.g., delete an entry, add an entry, or change each item of an entry).

Next, an example of a control method for the communication system 120 will be described with reference to FIG. 6. The method of FIG. 6 may be performed repeatedly during operation of the communication system 120.

In step S601, the session manager 125 determines whether or not an instruction to edit the transfer information 500 (i.e., an editing instruction) has been received from an external entity. If it is determined that an editing instruction has been received (YES in step S601), the session manager 125 transitions the processing to step S602, and if not (NO in step S601), repeats step S601. The editing instruction may include the designation of the subscriber identification information of the subscriber to be edited and the editing content.

In step S602, the session manager 125 updates the transfer information 500 in accordance with the editing instruction. Updating the transfer information 500 includes updating the subscriber identification information that is subject to communication restriction. For example, if the transfer destination (column 502) of the entry having the specific subscriber identification information designated in the editing instruction is changed from a transfer server to a low-speed server or a blocking server, packet communication by the UE 130 associated with this specific subscriber identification information will be restricted. If the transfer destination (column 502) of the entry having the specific subscriber identification information designated in the editing instruction is changed from a low-speed server or a blocking server to a transfer server, the restriction on packet communication by the UE 130 associated with this specific subscriber identification information will be removed. Restrictions related to a messaging service may be set or removed in a similar manner.

If a plurality of pieces of subscriber identification information (e.g., IMSIs) are assigned to one UE 130 and there is an instruction to edit one of the pieces of subscriber identification information, the session manager 125 may update only the entry for that one piece of subscriber identification information. Alternatively, the session manager 125 may update not only the entry for the one piece of subscriber identification information, but also the entries for the remaining subscriber identification information according to the editing content of the editing instruction.

In step S603, the session manager 125 determines whether the update of the transfer information 500 in step S602 includes a change in the transfer destination (column 502). If the session manager 125 determines that the update of the transfer information 500 includes a change of the transfer destination (“YES” in step S603), the session manager 125 transitions the processing to step S604, and if not (“NO” in step S603), transitions the processing to step S601. In step S604, the session manager 125 instructs the Tier-1 server 122 to disconnect the session with the UE 130 associated with the subscriber identification information of the entry whose transfer destination has been changed.

In step S605, the Tier-1 server 122 determines whether or not a session with the UE 130 indicated in step S604 has been established. If it is determined that a session has been established (“YES” in step S605), the Tier-1 server 122 transitions the processing to step S606, and if not (“NO” in step S605), transitions the processing to step S601. In step S606, the Tier-1 server 122 disconnects the session with the UE 130 instructed in step S604.

Even if the Tier-2 server 123 that is the transfer destination of the packets is changed, the Tier-1 server 122 continues to transfer the packets to the Tier-2 server 123 before the change as long as the session with the UE 130 is maintained. For this reason, even if an instruction is given to restrict packet communication of a specific user device, this restriction is not immediately reflected. In view of this, if the communication system 120 is instructed to restrict packet communication of a specific user device (e.g., if the transfer destination of the packet is changed to a low-speed server or a blocking server), the communication system 120 disconnects the session with the UE 130 such that this restriction is reflected. The same applies to removing a restriction on packet communication for a specific user device.

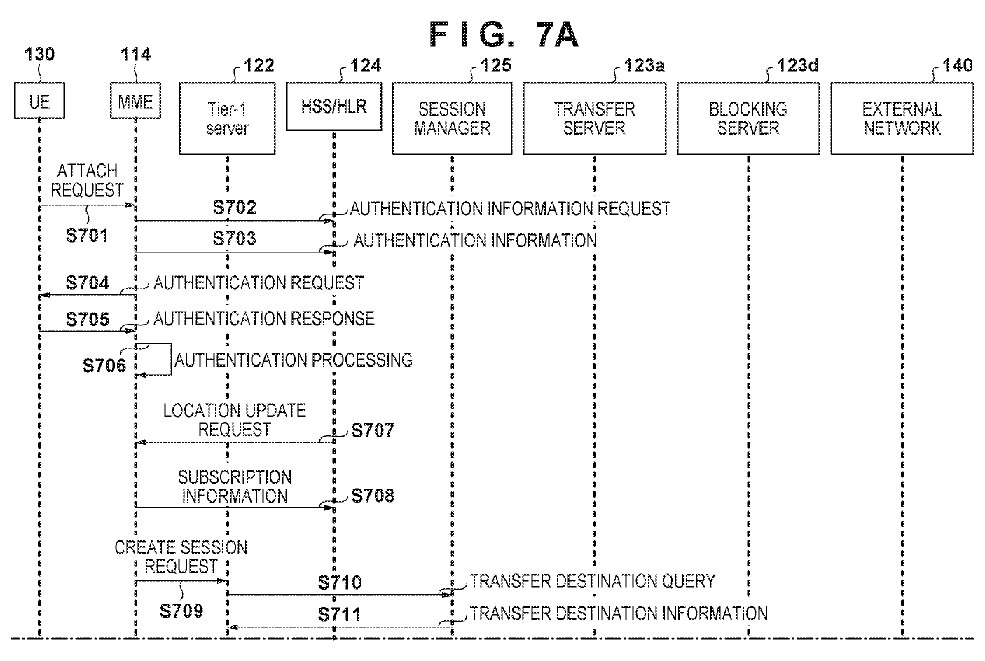

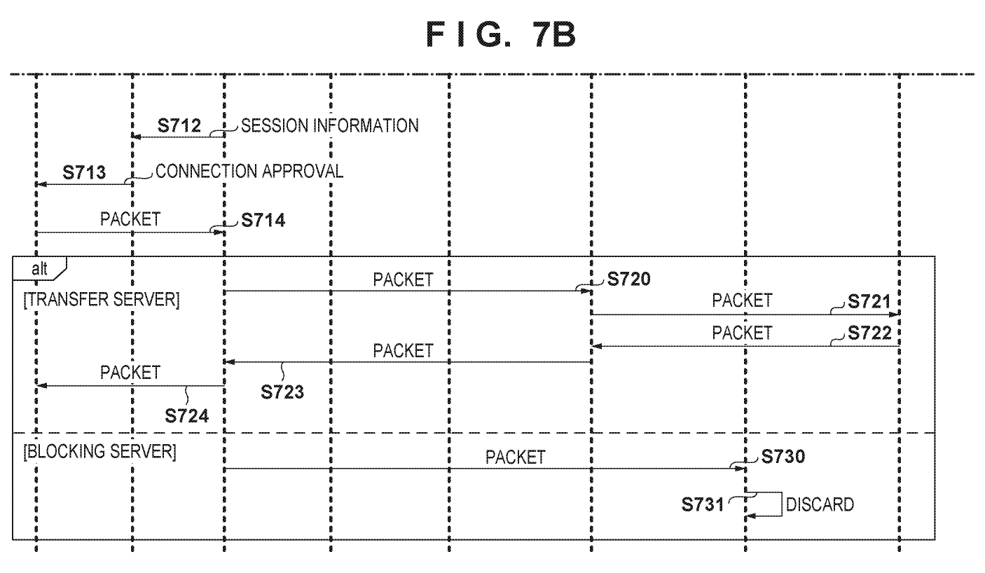

Next, the overall operation of the communication system 120 for packet communication will be described with reference to FIGS. 7A and 7B. In the following description, processing for one specific UE 130 will be described. Through FIGS. 7A and 7B, the UE 130 represents the same UE unless otherwise stated. In FIGS. 7A and 7B, processing relating to a restriction on packet communication will mainly be described. For this reason, in FIGS. 7A and 7B, some of the processing for establishing a session between the UE 130 and the mobile communication network 100 may be omitted. In addition, the processing for establishing a session between the UE 130 and the mobile communication network 100 (e.g., the authentication processing of steps S701 to S706) is not limited to the example of FIG. 7A, and other processing may also be performed. In the processing of FIGS. 7A to 9, communication between the UE 130 and the communication system 120 is relayed by the communication system 110. In the processing of FIGS. 7A to 9, unless otherwise stated, the latter of two consecutive operations may be executed depending on the previous operation.

In step S701, the UE 130 transmits an attach request to the MME 114. The attach request includes the subscriber identification information (e.g., IMSI) of the UE 130. In step S702, the MME 114 transmits an authentication information request to the HSS/HLR 124 requesting authentication information of the UE 130. The authentication information request includes the subscriber identification information of the UE 130 (e.g., the IMSI). In step S703, the HSS/HLR 124 responds to the MME 114 with authentication information corresponding to the subscriber identification information to be processed.

In step S704, the MME 114 transmits to the UE 130 an authentication request generated based on the authentication information received from the HSS/HLR 124. In step S705, the UE 130 responds to the authentication request. In step S706, the MME 114 executes authentication processing on the UE 130 based on the response, thereby determining whether or not the user of the UE 130 is an authorized user.

In the example of FIG. 7A, it is assumed that the UE 130 was correctly authenticated. In step S707, the MME 114 transmits a location update request requesting an update of the location of the UE 130 to the HSS/HLR 124. The location update request includes the subscriber identification information (e.g., IMSI) of the UE 130 and the current location of the UE 130. In response to the location update request, the HSS/HLR 124 updates the location information of the UE 130. In step S708, the HSS/HLR 124 transmits the subscription information to the MME 114. The subscription information may include, for example, the details of permitted services, the contracted Access Point Name (APN), and settings related to Quality of Service (QoS). The MME 114 stores this subscription information and transfers packets from the UE 130 to the Tier-1 server 122 for subsequent processing based on the subscription information. The MME 114 also transmits subscription information to the UE 130.

If a session is to be created simultaneously with the initial connection, the MME 114 transmits to the Tier-1 server 122 a create session request requesting creation of a session between the UE 130 and the P-GW 121 in step S709. The communication system 110 establishes a GTP tunnel (GTP-C) for the control plane (C-plane) between itself and one or more Tier-1 servers 122, and transmits a create session request to the Tier-1 server 122 through this GTP tunnel. For example, the MME 114 selects one Tier-1 server 122 from one or more Tier-1 servers 122 connected to the communication system 110 in a round robin manner. The create session request includes the subscriber identification information (e.g., IMSI) of the UE 130. The MME 114 may transmit a create session request to the Tier-1 server 122 in response to a request from the UE 130 after the initial connection processing.

In step S710, the Tier-1 server 122 queries the session manager 125 as to which one of the plurality of Tier-2 servers 123 the packet is to be transferred to, for the processing-target subscriber identification information included in the create session request. This query includes the processing-target subscriber identification information.

In step S711, the session manager 125 refers to the transfer information 500 to specify the Tier-2 server 123 (column 502) associated with the processing-target subscriber identification information (column 501) that is included in the query from the Tier-1 server 122. As described for the transfer information 500, if the processing-target subscriber identification information is restricted from packet communication, the session manager 125 selects the low-speed server 123c or the blocking server 123d. If the processing-target subscriber identification information is not restricted from packet communication, the session manager 125 selects the transfer server 123a or the transfer server 123b. The session manager 125 responds to the Tier-1 server 122 with information for connecting to the specified Tier-2 server 123. For example, the session manager 125 responds with routing information such as the IP address of the specified Tier-2 server 123. The Tier-2 server 123 specified by the session manager 125 becomes the Tier-2 server 123 that is the transfer destination of the packets of the UE 130. The Tier-1 server 122 stores the information received from the session manager 125 (including the IP address of the Tier-2 server 123 which is the transfer destination) in association with the IP address assigned to the UE 130 for subsequent processing.

In step S712, the Tier-1 server 122 assigns an IP address to the UE 130 and transmits the IP address to the UE 130. Furthermore, the Tier-1 server 122 establishes a session between the UE 130 and the Tier-2 server 123 that is the transfer destination of the UE 130. In addition, tunnel endpoint identifiers (TEIDs) may be agreed upon between the S-GW 112 and the Tier-1 server 122, and between the Tier-1 server 122 and the Tier-2 server 123 that is the transfer destination. In step S713, the MME 114 notifies the UE 130 that the connection has been approved.

As described above, the communication system 120 executes the processing of steps S701 to S713 in the C-plane regardless of whether the UE 130 is subject to packet communication restriction. In this way, the communication system 120 does not restrict the C-plane communication of the UE 130 even if the UE 130 is subject to packet communication restriction. That is, the communication system 120 performs the same processing on the C-plane for a restricted UE and a non-restricted UE if the conditions other than the packet communication restriction are the same.

In step S714, the UE 130 transmits IP packets for a server in the external network 140 to the Tier-1 server 122 through the session. This IP packet may be an IP packet for transmitting data of any application that uses the TCP/IP protocol stack, and may be an IP packet for transmitting an HTTP request, for example. Step S714 may be performed upon request by this application. The UE 130 sets the IP address transmitted in step S712 as the transmission source IP address of this IP packet.

The subsequent processing differs depending on whether or not the processing-target UE 130 is restricted from packet communication. First, a case will be described in which packet communication of the processing-target UE 130 is not restricted. In the example of FIG. 4, the UE 130a and the UE 130b correspond to such UEs 130. As described above, packets transmitted from the UE 130a are transferred to the transfer server 123a, and packets transmitted from the UE 130b are transferred to the transfer server 123b.

In step S720, the Tier-1 server 122 transfers the IP packets transmitted by the UE 130 to a transfer server (e.g., the transfer server 123a) through the session established in step S712. In this transfer, the GTP packet is transmitted to the IP address of the Tier-2 server 123 associated with the TEID included in the GTP packet. This TEID is uniquely associated with the subscriber identification information (e.g., IMSI) of the UE 130. For this reason, the IP packet transmitted by the UE 130 is transferred to the Tier-2 server 123 set for the subscriber identification information of the UE 130 (in this example, the transfer server 123a). The method of transferring IP packets to the Tier-2 server 123 set for the subscriber identification information of the UE 130 is not limited to the method of using the TEID in this way, and the packets may be transferred in other ways. In step S721, the transfer server 123a terminates the session, extracts the IP packets from the GTP packets, and transfers them to the external network 140 (e.g., the private network 140a).

In step S722, the transfer server 123a receives an IP packet including a response to the request from the external network 140. In step S723, the transfer server 123a adds a GTP header to this IP packet and then transfers it to the Tier-1 server 122. In step S724, the Tier-1 server 122 transfers the GTP packets to the UE 130 through the session. The Tier-1 server 122 may then tear down the session between the UE 130 and the transfer server 123a.

Next, a case where the processing-target UE 130 is restricted from packet communication will be described. In the example of FIG. 4 described above, the UE 130c and the UE 130d correspond to this kind of UE 130. The packets transmitted from the UE 130c are transferred to the low-speed server 123c. The processing of packets transmitted from the UE 130c may be similar to steps S720 to S724, except that some packets are discarded in step S721. In view of this, a case where the processing-target UE 130 is prohibited from packet communication (i.e., a case where the processing-target UE 130 is the UE 130d) will be described. The packets transmitted from the UE 130d are transferred to the blocking server 123d.

In step S730, the Tier-1 server 122 transfers the IP packets transmitted by the UE 130 to the blocking server 123d through the session established in step S712. In this transfer, the GTP packet is transmitted to the IP address of the Tier-2 server 123 associated with the TEID included in the GTP packet. In step S731, the blocking server 123d discards the IP packets transmitted by the UE 130. For example, the blocking server 123d may discard the GTP packet that includes the IP packet, or may discard the IP packet after extracting it from the GTP packet. If the IP packet is discarded, the request transmitted from the UE 130 in step S714 may time out. In the above example, the IP packets transmitted by the UE 130 are transmitted to the Tier-2 server 123 through the session. Alternatively, the IP packets transmitted by the UE 130 may be transmitted either through a tunnel using another protocol (e.g., Segment Routing over IPv6 (SRv6)), or without using a tunnel.

As described above, the communication system 120 restricts communication in the U-plane when the UE 130 is subject to restriction on packet communication. The UEs 130 that are subject to restriction are managed by the session manager 125 in association with subscriber identification information. For this reason, even if the SIM 131 is replaced in another UE 130, for example, communication from subscribers who are managed as being subject to communication restriction can be restricted as intended. According to the above-described embodiment, it is possible to set and remove the restriction on packet communication of the UE 130 by merely changing the transfer destination of packets in the U-plane. For this reason, it is not necessary to change the settings of the UE 130 (e.g., to set the status of the SIM 131 to suspended), and therefore it is not necessary to restart the UE 130 to remove the restriction. In addition, in the above-described embodiment, packet communication in the U-plane is restricted, but communication in the C-plane is not restricted. This reduces excessive requests in the C-plane (e.g., create session requests).

In the method of FIGS. 7A and 7B, the communication system 120 does not restrict communication in the C-plane, but restricts communication in the U-plane. Alternatively, the communication system 120 may restrict communication patterns based on authorization information transmitted in the C-plane. For example, the HSS/HLR 124 may query the session manager 125 about communication restrictions for the processing-target subscriber identification information before transmitting the subscriber contract information in step S708 described above. Based on the result of this query, the HSS/HLR 124 determines the information to be transmitted to the MME 114 in step S708. For example, if the HSS/HLR 124 is notified by the session manager 125 that communication is restricted for the processing-target subscriber identification information, the HSS/HLR 124 may transmit, to the MME 114, authorization information including information indicating that communication has been restricted (e.g., whether or not data communication is possible, restriction on the maximum bit rate, whether or not SMS message transmission is possible, etc.). Denying data communication may mean restricting communication in the U-plane without restricting communication in the C-plane, or may mean denying location registration or session creation itself in the C-plane. The HSS/HLR 124 may transmit such authorization information to the MME 114 not only when the UE 130 initially connects, but also in response to the transfer information 500 being updated. The transfer information 500 may also include a setting regarding whether to restrict communication in the U-plane without restricting communication in the C-plane, or to restrict communication patterns based on authorization information transmitted in the C-plane. Based on this setting, the session manager 125 may determine the information to transmit to the MME 114 in step S708.

The communication system 120 may execute a combination of a method of restricting communication in the U-plane without restricting communication in the C-plane and a method of restricting communication in the C-plane without establishing the U-plane. It may be possible to set which of these two methods is to be executed for each piece of subscriber identification information, and this setting may be stored in the transfer information 500.

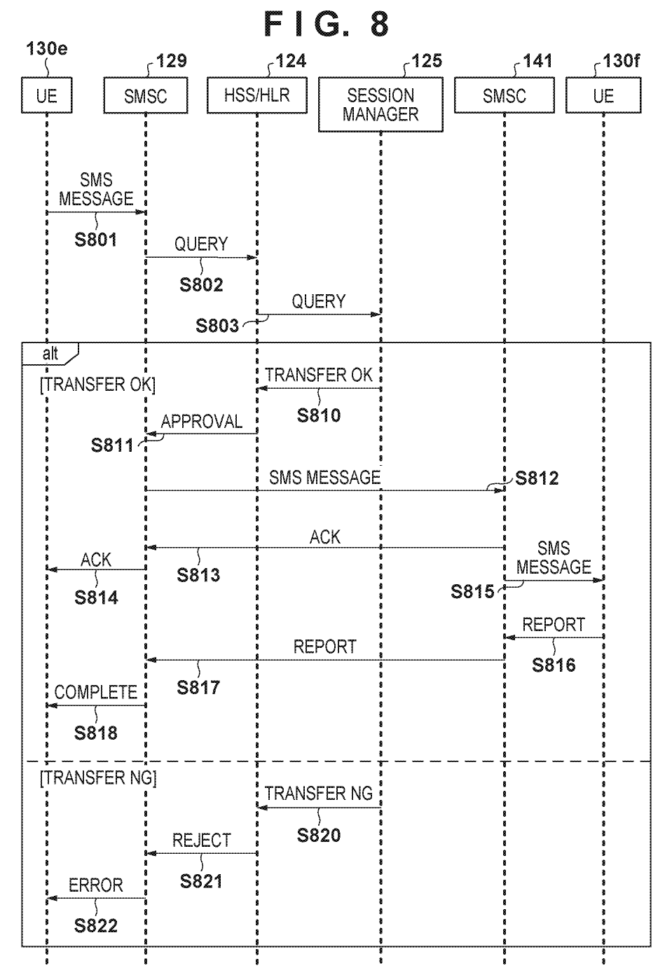

The overall operation of the communication system 120 for communicating SMS messages will subsequently be described with reference to FIG. 8. In the following description, the processing for one specific UE 130e will be described. In step S801, the UE 130e transmits a transmission request to the SMSC 129 to transmit an SMS message. The transmission request received by the SMSC 129 includes the subscriber identification information of the UE 130e (e.g., the IMSI stored in the UE 130e and the phone number (e.g., MSISDN) assigned to the UE 130e) and the body of the SMS message.

In step S802, the SMSC 129 queries the HSS/HLR 124 about whether or not the subscriber who made the transmission request has the authority to transmit an SMS message. The query includes the subscriber identification information (e.g., MSISDN) of the UE 130e. In step S803, the HSS/HLR 124 determines whether or not the subscriber identified by the subscriber identification information included in the query is authorized to transmit an SMS message. Furthermore, the HSS/HLR 124 queries the session manager 125 about whether or not the subscriber identification information included in the query is restricted from transmitting a SMS message. The query includes the subscriber identification information (e.g., MSISDN) of the UE 130e. The session manager 125 refers to column 503 of the transfer information 500 to determine whether or not the processing-target subscriber identification information (column 501) that is included in the query from the HSS/HLR 124 is restricted from transmitting an SMS message.

The subsequent processing differs depending on whether or not the processing-target UE 130e is restricted from transmitting an SMS message. First, a case will be described in which the processing-target UE 130e is not restricted from transmitting an SMS message. In step S810, the session manager 125 notifies the HSS/HLR 124 that the target UE 130e is not restricted from transmitting an SMS message. In step S811, the HSS/HLR 124 approves transmission of the SMS message for the SMSC 129 if the UE 130e has the authority to transmit the SMS message. If the UE 130e does not have the authority to send an SMS message, the processing proceeds to step S821, which will be described later.

In step S812, the SMSC 129 transfers the SMS message transmitted from the UE 130e to the SMSC 141 by Short Message Peer to Peer (SMPP). In step S813, the SMSC 141 transmits an ACK to the SMSC 129 as a response. In step S815, the SMSC 141 transmits the SMS message to the UE 130f, which is the destination of the SMS message. In step S816, the UE 130f that has received the SMS message transmits a reception report to the SMSC 141. In step S817, the SMSC 141 transfers this reception report to the SMSC 129. In step S818, the SMSC 129 notifies the UE 130e that the transmission of the SMS message is complete. In this example, the destination of the SMS message is the UE 130 (UE 130f in the example of FIG. 8), but the destination of the SMS message may also be a server.

Next, a case in which the processing-target UE 130e is restricted from transmitting an SMS message will be described. In step S820, the session manager 125 notifies the HSS/HLR 124 that the processing-target UE 130e is restricted from transmitting an SMS message. In step S821, the HSS/HLR 124 denies the SMSC 129 the transmission of the SMS message. In step S822, the SMSC 129 discards the SMS message transmitted from the UE 130e and notifies the UE 130e that the transmission of the SMS message has failed.

FIG. 8 illustrates a case in which the UE 130e transmits an SMS message. The communication system 120 may receive an SMS message intended for the UE 130e and discard the SMS message if the UE 130e is restricted from using the SMS service. In this way, the communication system 120 restricts communication in the messaging service of the restricted user device. As described above, transmitting and receiving SMS messages may also be restricted independently. Furthermore, transmission or reception of SMS messages may be restricted or permitted only to specific destinations.

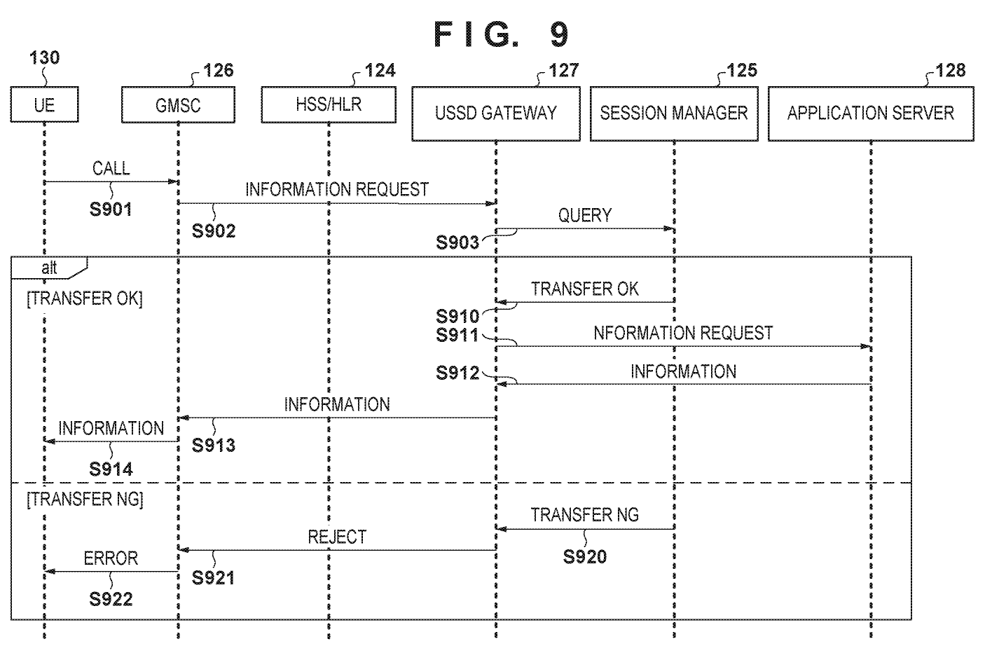

Next, the overall operation of the communication system 120 for communicating USSD messages will be described with reference to FIG. 9. In the following description, processing for one specific UE 130 will be described. Through FIG. 9, the UE 130 represents the same UE unless otherwise stated. In the description of FIG. 9, it is assumed that authentication of the user of the UE 130 has ended in the same manner as in steps S701 to S706 of FIG. 7A.

In step S901, the UE 130 calls a dedicated phone number assigned to the GMSC 126 to transmit a USSD message. The call includes the subscriber identification information of the UE 130 (e.g., IMSI), the phone number assigned to the UE 130 (e.g., MSISDN), and the body of the USSD message. The body of the USSD message may also be a request for information to the application server 128.

In step S902, the GMSC 126 transmits a USSD message requesting information to the USSD gateway 127. In step S903, the USSD gateway 127 queries the session manager 125 about whether or not transmission of the USSD message is restricted for the subscriber identification information included in the USSD message. The query includes the subscriber identification information of the UE 130 (e.g., the IMSI). The session manager 125 refers to column 504 of the transfer information 500 to determine whether or not transmission of USSD messages is restricted for the processing-target subscriber identification information (column 501) that is included in the query from the USSD gateway 127.

The subsequent processing differs depending on whether or not the processing-target UE 130 is restricted from transmitting USSD messages. First, a case in which the processing target UE 130 is not restricted from transmitting USSD messages will be described. In step S910, the session manager 125 notifies the USSD gateway 127 that the target UE 130 is not restricted from transmitting USSD messages. In step S911, the USSD gateway 127 transfers the USSD message transmitted from the UE 130 to the application server 128. In step S912, the application server 128 responds with the information requested in the USSD message. In step S913, the USSD gateway 127 transfers this information to the GMSC 126. In step S914 , the GMSC 126 transfers this information to the UE 130.

Next, a case in which the target UE 130 is restricted from transmitting USSD messages will be described. In step S920, the session manager 125 notifies the USSD gateway 127 that the target UE 130 is restricted from transmitting USSD messages. In step S921, the USSD gateway 127 discards the USSD message transmitted from the UE 130 and rejects the transmission of the USSD message to the GMSC 126. In step S922, the GMSC 126 notifies the UE 130 that the transmission of the USSD message has failed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A communication system comprising:
a communication unit configured to perform processing related to communication of a user device; and
a management unit configured to managing subscriber identification information that is subject to communication restriction,
wherein the communication unit restricts communication of a restricted user device associated with subscriber identification information that is managed as being subject to communication restriction.

2. The communication system according to claim 1,
wherein the communication unit restricts communication in a user plane of the restricted user device.

3. The communication system according to claim 2,
wherein the communication unit does not restrict communication in a control plane of the restricted user device.

4. The communication system according to claim 1,
wherein the communication unit includes:
a first server configured to receive packets transmitted by a user device; and
a plurality of second servers configured to receive the packets transferred from the first server,
the plurality of second servers include:
a transfer server configured to transfer the packets transferred from the first server, to an external network; and
a restricting server configured to discard at least a portion of the packets transferred from the first server,
the first server transfers, to the transfer server, packets transmitted by a user device associated with subscriber identification information that is not subject to packet communication restriction, and
the first server transfers, to the restricting server, packets transmitted by a user device associated with subscriber identification information that is subject to packet communication restriction.

5. The communication system according to claim 4,
wherein the restricting server discards all of the packets transferred from the first server.

6. The communication system according to claim 4,
wherein the first server queries the management unit about which of the plurality of second servers a packet is to be transferred to, based on processing-target subscriber identification information,
the management unit specifies one second server among the plurality of second servers based on whether packet communication is restricted for the processing-target subscriber identification information,
the first server stores an address of the second server specified by the management unit, and
the first server transfers packets transmitted from a user device associated with the processing-target subscriber identification information to the stored address.

7. The communication system of claim 6,
wherein in response to receiving a create session request including the processing-target subscriber identification information from a user device, the first server queries the management unit about which of the plurality of second servers a packet is to be transferred to, based on the processing-target subscriber identification information.

8. The communication system according to claim 1,
wherein the management unit updates a communication restriction setting based on an instruction from an external entity.

9. The communication system according to claim 8,
wherein in a case where a session has been established between a specific user device and the communication unit when an instruction to restrict or release a restriction on packet communication of the specific user device is received, the communication unit disconnects the session.

10. The communication system according to claim 4,
wherein the plurality of second servers include:
a low-speed server configured to discard only a portion of the packets transferred from the first server; and
a blocking server configured to discard all of the packets transferred from the first server.

11. The communication system according to claim 1,
wherein the communication unit restricts communication in a messaging service of the restricted user device.

12. The communication system according to claim 11,
wherein the communication unit discards a message transmitted from the restricted user device.

13. The communication system of claim 12,
wherein the message is an SMS message or a USSD message.

14. The communication system according to claim 1,
wherein the management unit manages subscriber identification information that is subject to communication restriction separately for packet communication and a messaging service.

15. A non-transitory computer readable storage medium storing a program for causing one or more computers to function as the communication system according to claim 1.

16. A method for controlling a communication system, the method comprising:
performing processing related to communication of a user device; and
managing subscriber identification information that is subject to communication restriction;
wherein performing the processing includes restricting communication of a restricted user device associated with subscriber identification information managed as being subject to communication restriction.
